(19) United States
(12) Patent Application Publication
(10) Pub. No.: US 2024/0353832 A1
(43) Pub. Date: Oct. 24, 2024

(54) SECURE COMPUTING SYSTEM, INFORMATION PROCESSING SYSTEM, SECURE COMPUTING METHOD, AND RECORDING MEDIUM

(71) Applicant: NEC Corporation, Minato-ku, Tokyo (JP)

(72) Inventor: Yoji Mori, Tokyo (JP)

(73) Assignee: NEC Corporation, Minato-ku, Tokyo (JP)

(21) Appl. No.: 18/690,326

(22) PCT Filed: Sep. 28, 2021
(86) PCT No.: PCT/JP2021/035504

§ 371 Date: Mar. 8, 2024

(51) Int. Cl. G05B 23/02

(52) U.S. Cl. CPC G05B 23/0283

(57) ABSTRACT

A secure computing system according to the present disclosure is used in an analysis pertaining to predictive maintenance of a semiconductor manufacturing device, and comprises: a parameter reception means that receives concealed parameters of a plurality of models generated by each of a plurality of semiconductor manufacturers; a secure computing means that integrates the plurality of concealed parameters by secure computing; and an output means that outputs, in a concealed format, the parameters integrated by the secure computing means.

### TECHNICAL FIELD

The present disclosure relates to a secure computing system, an information processing system, a secure computing method, and a recording medium.

### BACKGROUND ART

A semiconductor manufacturing device manufacturer remotely monitors an operating status of a device supplied to a semiconductor manufacturer, and promptly copes with a sign of a failure or a defect of the semiconductor manufacturing device when detected, thereby preventing a decrease in productivity.

For example, PTL 1 discloses a system that creates a model for predicting a parameter of a maintenance part of a semiconductor manufacturing device based on a value of a meta-parameter included in a model for predicting the lifespan of the maintenance part and calculates the predicted lifespan.

### CITATION LIST

### Patent Literature

PTL 1: WO 2012/157040 A1

### SUMMARY OF INVENTION

### Technical Problem

However, in the invention described in PTL 1, since data predicted by a single prediction model and is output, there is a limit in improving the accuracy of the predicted data. At the time of performing analysis on necessity of maintaining a semiconductor manufacturing device, by information from models owned by a plurality of semiconductor manufacturers than using a model owned by an individual semiconductor manufacturer, a more accurate model can be generated. However, the models owned by the semiconductor manufacturers cannot be provided to a third party because they include confidential information.

An object of the present disclosure is to provide more accurate models while concealing respective parameters of the models.

### Solution to Problem

A secure computing system according to an aspect of the present disclosure includes a parameter reception means that receives concealed parameters of a plurality of models generated for a plurality of semiconductor manufacturers, each of the plurality of models being used for analysis related to predictive maintenance of a semiconductor manufacturing device, a secure computing means that integrates the plurality of concealed parameters through secure computation, and an output means that outputs the parameters integrated by the secure computing means in a concealed form.

A predictive maintenance system according to an aspect of the present disclosure is an information processing system including a plurality of semiconductor manufacturer servers and a secure computing system, in which each of the plurality of semiconductor manufacturer servers includes a model storage unit that stores a model generated based on a parameter related to an operating status of a semiconductor manufacturing device to perform analysis related to predictive maintenance of the semiconductor manufacturing device, a concealing unit that conceals the parameter of the model stored in the model storage unit, a model input/output means that transmits the model concealed by the concealing unit to the secure computing system in a concealed form, a restoration unit that restores the concealed parameter, and the secure computing system includes a parameter reception means that receives concealed parameters of a plurality of models generated for a plurality of semiconductor manufacturers, each of the plurality of models being used for analysis related to predictive maintenance of a semiconductor manufacturing device, a secure computing means that integrates the plurality of concealed parameters through secure computation, and an output means that outputs the parameters integrated by the secure computing means in a concealed form.

A device management method according to an aspect of the present disclosure includes receiving concealed parameters of a plurality of models generated for a plurality of semiconductor manufacturers, each of the plurality of models being used for analysis related to predictive maintenance of a semiconductor manufacturing device, integrating the plurality of concealed parameters through secure computation, and outputting the integrated parameters in a concealed form.

A recording medium according to an aspect of the present disclosure stores a program for causing a computer to execute receiving concealed parameters of a plurality of models generated for a plurality of semiconductor manufacturers, each of the plurality of models being used for analysis related to predictive maintenance of a semiconductor manufacturing device, integrating the plurality of concealed parameters through secure computation, and outputting the integrated parameters in a concealed form.

### Advantageous Effects of Invention

As an effect of the present disclosure, it is possible to provide more accurate models while concealing respective parameters of the models.

### BRIEF DESCRIPTION OF DRAWINGS

FIG. 1 is a block diagram illustrating a configuration of an information processing system according to a first example embodiment.

FIG. 2 is a diagram illustrating a hardware configuration in which a secure computing system according to the first example embodiment is implemented by a computer device and its peripheral device.

FIG. 3 is a flowchart illustrating a secure computation operation according to the first example embodiment.

FIG. 4 is a block diagram illustrating a configuration of an information processing system according to a second example embodiment.

FIG. 5 is a flowchart illustrating an information processing operation according to the second example embodiment.

### EXAMPLE EMBODIMENT

Next, example embodiments will be described in detail with reference to the drawings.

### First Example Embodiment

An information processing system 10 according to the first example embodiment is a system for integrating a plurality of parameters of models for predictive maintenance analysis using parameters related to operation situations owned by semiconductor manufacturers through secure computation.

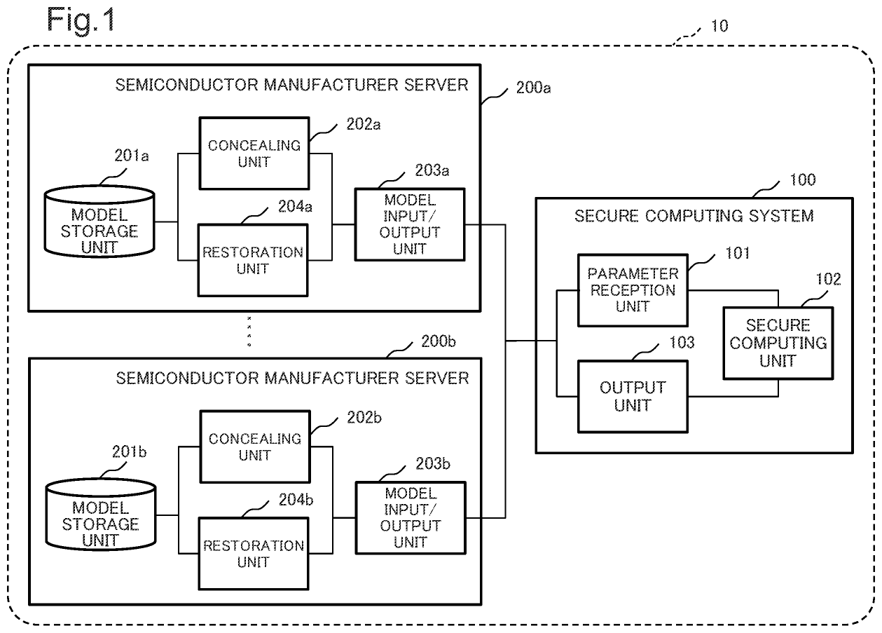

FIG. 1 is a block diagram illustrating a configuration of the information processing system 10 according to the first example embodiment. Referring to FIG. 1, the information processing system 10 includes a secure computing system 100 and a plurality of semiconductor manufacturer servers 200 (200a and 200b). The secure computing system 100 includes a parameter reception unit 101, a secure computing unit 102, and an output unit 103. The secure computing system 100 is implemented by, for example, a service provider (user) who is entrusted with predictive maintenance services such as repairs and checks of semiconductor manufacturing devices. The service provider integrates parameters of models that have been trained for the respective semiconductor manufacturer servers 200, and provides the predictive maintenance services or the like using an update model to which the integrated parameters are applied. The predictive maintenance means, for example, measuring and monitoring a state of a semiconductor manufacturing device, grasping or predicting a deterioration state of equipment, and replacing or repairing parts.

The plurality of semiconductor manufacturer servers 200 are servers of a plurality of customers (e.g., competing semiconductor manufacturers) of the semiconductor manufacturing device manufacturer. In this case, the parameters of the competitors can be analyzed together while being kept concealed. Another example in which the plurality of semiconductor manufacturer servers 200 are installed is a case where parameters are stored in different servers by lot even in the same factory.

Each of the semiconductor manufacturer servers 200 includes a model storage unit 201 (201a or 201b) that stores a model that has been trained to perform analysis related to predictive maintenance of the semiconductor manufacturing device, a concealing unit 202 (202a or 202b) that conceals a parameter of the model, a model input/output unit 203 (203a or 203b) that inputs and outputs a parameter to and from the secure computing system 100, and a restoration unit 204 (204a or 204b) that restores the concealed parameter. In the present example embodiment, the plurality of semiconductor manufacturer servers 200 are provided at two locations, but the present disclosure is not limited thereto. The plurality of semiconductor manufacturer servers 200 are provided as many as the number of semiconductor manufacturers from which parameters are integrated. Hereinafter, the secure computing system 100, which is an essential component of the present example embodiment, will be described in detail.

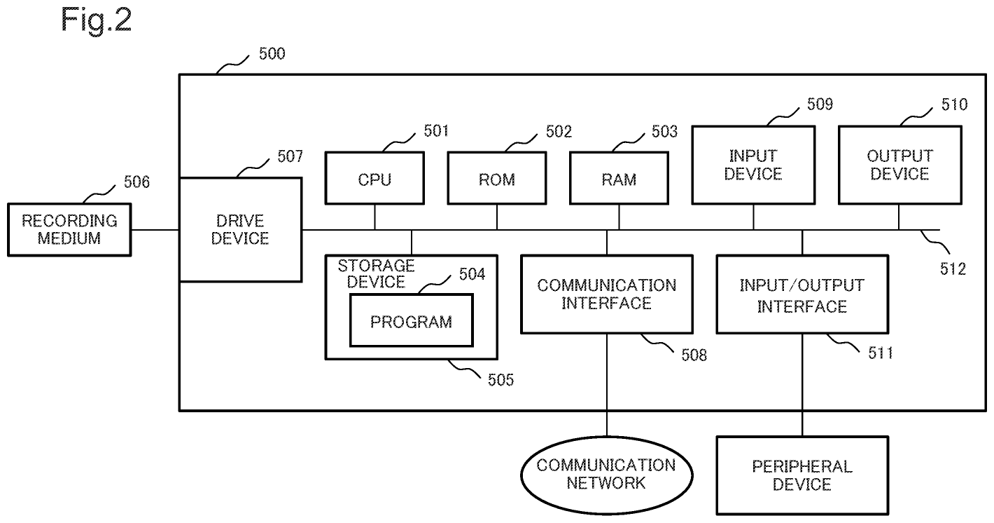

FIG. 2 is a diagram illustrating an example of a hardware configuration in which the secure computing system 100 of the semiconductor manufacturing device according to the first example embodiment of the present disclosure is implemented by a computer device 500 including a processor. As illustrated in FIG. 2, the secure computing system 100 includes a central processing unit (CPU) 501, memories such as a read only memory (ROM) 502 and a random access memory (RAM) 503, a storage device 505 such as a hard disk that stores a program 504, a communication interface (I/F) 508 for network connection, and an input/output interface 511 that inputs and outputs data. In the first example embodiment, parameter information received from each semiconductor manufacturer server 200 is input to the secure computing system 100 via the communication I/F 508.

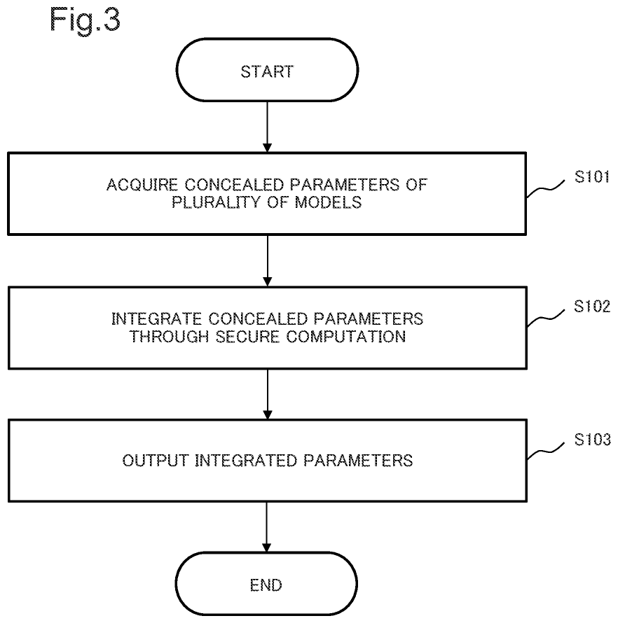

The CPU 501 operates an operating system to control the entire secure computing system 100 according to the first example embodiment of the present invention. In addition, the CPU 501 reads a program or data from a recording medium 506 mounted on, for example, a drive device 507 to a memory. In addition, the CPU 501 functions as the parameter reception unit 101, the secure computing unit 102, and the output unit 103, or some of them in the first example embodiment, and executes a process or a command in a flowchart illustrated in FIG. 3 to be described below based on the program.

The recording medium 506 is, for example, an optical disk, a flexible disk, a magneto-optical disk, an external hard disk, a semiconductor memory, or the like. Some recording media of the storage device are non-volatile storage devices, and programs are recorded therein. In addition, programs may be downloaded from an external computer connected to a communication network although not illustrated.

The input device 509 is implemented by, for example, a mouse, a keyboard, a built-in key button, or the like, and is used for an input operation. The input device 509 is not limited to the mouse, the keyboard, and the built-in key button, and may be, for example, a touch panel. The output device 510 is implemented by, for example, a display, and is used to confirm an output.

As described above, the first example embodiment illustrated in FIG. 1 is implemented by the computer hardware illustrated in FIG. 2. However, the means for implementing each of the units included in the secure computing system 100 for manufacturing semiconductors of FIG. 1 is not limited to the above-described configuration. In addition, the secure computing system 100 may be implemented by one physically coupled device, or may be implemented by two or more physically separated devices by connecting the plurality of devices to each other in a wired or wireless manner. For example, the input device 509 and the output device 510 may be connected to the computer device 500 via a network. In addition, the secure computing system 100 according to the first example embodiment illustrated in FIG. 1 may be configured by cloud computing or the like.

In FIG. 1, a parameter reception unit 101 is a means that receives a concealed parameter of a plurality of models used for analysis related to predictive maintenance of semiconductor manufacturing devices and generated in a plurality of semiconductor manufacturer servers, from the plurality of models. The analysis related to predictive maintenance of the semiconductor manufacturing devices is analysis on necessity of maintaining parts used in the semiconductor manufacturing devices. The semiconductor manufacturing devices refer to general devices used for manufacturing semiconductors. Examples of the semiconductor manufacturing devices include manufacturing devices used in a process of forming elements on wafers, which is a pre-process of a semiconductor manufacturing process, such as a diffusion/thermal oxidation device, a film formation-related device (including an etching device), a coater/developer device, an exposure device, a cleaning/etching device, and an ion implantation/annealing device. Examples of the film formation-related device include a plasma chemical vapor deposition (CVD) device, a dry etching device (RIE), an RF plasma device, a sputtering device, and a CVD device.

The parameter is a parameter related to an operating status of a semiconductor manufacturing device. More specifically, the parameter is a parameter that varies depending on the operating time of the semiconductor manufacturing device and is capable of predicting necessity of maintaining a specific unit in the semiconductor manufacturing device. The part used in the semiconductor manufacturing device is, for example, a part that particularly affects the yield and the accuracy of the manufactured semiconductor among parts used in the semiconductor manufacturing device. Examples of the part used in the semiconductor manufacturing device include a heating lamp, a light source, an ion source, a turbo molecular pump, a vacuum valve, and a chamber.

The parameters are classified as, for example, a process parameter or an operation status parameter. The process parameter is, for example, a value obtained by measuring a physical quantity in the manufacturing device when the semiconductor manufacturing device is in operation, and is obtained from a value of a sensor attached to the semiconductor manufacturing device. Examples of the sensor include a current sensor, a temperature sensor, a vibration sensor, and an acceleration sensor. Examples of the process parameter include a consumption current and a vibration level in a specific unit of the semiconductor manufacturing device. Examples of other process parameters in the film formation-related device include a gas flow rate, a film formation time, a substrate temperature, a Vpp voltage and a Vdc voltage (plasma CVD and dry etching), a DC bias (sputtering), and a pressure. Examples of process parameters of a semiconductor manufacturing device other than the film formation-related device include a cleaning level and an etching depth in the cleaning/etching device. Examples of process parameters in the diffusion/thermal oxidation device include a depth, a thickness, and a sheet resistance of an oxide film. Examples of process parameters in the ion implantation/annealing device include a profile sheet resistance. Examples of process parameters in the coater/developer include a resist pattern.

The operation status parameter is a parameter indicating a setting condition during operation of the semiconductor manufacturing device. Examples of the operation status parameters for plasma CVD in the film formation-related device include an input power, a reflected wave→0 (closeness to 0 of reflection coefficient), an ultimate vacuum degree in a chamber, and a heating lamp power. Examples of the operation status parameters for dry etching include an ultimate vacuum degree and a heating lamp power. Examples of the operation status parameters for RF plasma include an incident wave Pf, a reflected wave Pr, a value of a variable capacitor, and a heating lamp power. Examples of the operation status parameters in the sputtering device include an input power, a reflected wave, an ultimate vacuum degree, and a heating lamp electrode. Examples of the operation status parameters for CVD is a heating lamp power. Examples of operation status parameters other than those in the film formation-related device include a vacuum degree and an infrared lamp power in the ion implantation/annealing device. Examples of operation status parameters in the exposure device include a light source output. Examples of operation status parameters in the coater/developer includes an acceleration.

For example, with an operation for integrating parameters of models by the service provider as a trigger, the parameter reception unit 101 receives parameters of models that have been in the plurality of semiconductor manufacturer servers 200, via the communication I/F 508 through the network in a concealed form. The trained models are models trained based on homogeneous parameters in the plurality of semiconductor manufacturer servers 200. The homogeneous parameters are, for example, parameters related to specific parts in homogeneous semiconductor manufacturing devices. The model is a model that outputs a result of estimating necessity of maintaining a part in a semiconductor manufacturing device when a parameter related to an operating status of the semiconductor manufacturing device is input, for example, a model that outputs whether it is necessary to replace or repair a specific part when a difference from a reference value of the parameter of the semiconductor manufacturing device is input. The models to be trained include, but are not limited to, decision tree models, linear regression models, logistic regression models, neural networks models, and the like.

The secure computing unit 102 is a means that integrates the plurality of parameters concealed after being received by the parameter reception unit 101 through secure computation. In the present example embodiment, the integration of the plurality of concealed parameters through secure computation means collectively performing computation processing on parameters individually learned for the semiconductor manufacturer servers 210, in the concealed state. The secure computing unit 102 may integrate concealed parameters of a plurality of models through associative learning using secure computation. In this case, the secure computing unit 102 performs machine learning in a state where data is distributed to the semiconductor manufacturer servers 200, and integrates parameters of models that have been trained for the respective semiconductor manufacturer servers 200 by using secure computation.

The secure computing unit 102 integrates the concealed parameters in accordance with a predetermined rule. As a parameter integration method, a known method can be used, and for example, at the time of integration, a weight of the parameter corresponding to each model can be changed according to the feature of each model.

As a secure computing method, special encryption corresponding to specific processing such as homomorphic encryption, a trusted execution environment in which processing is performed in an isolated state on hardware, multi-party computation in which computation processing (secure distributed computation) is performed by a plurality of servers in a state where data is securely distributed, or the like can be used. As a specific method of multi-party computation as secure computation, the following example can be considered. For example, concealed data a is securely distributed as distribution values x1, y1 . . . , and the administrator transmits x1, y1, . . . to different servers, respectively. Concealed data b is securely distributed as distribution values x2, y2, . . . , and the administrator transmits x2, y2, . . . to different servers, respectively. Next, computation is performed while the different servers communicate with each other in a state where the concealed data a and the concealed data b are securely distributed, and output distribution values u, v, . . . , which are computation results of the respective servers, are collected and restoration processing is performed finally, thereby obtaining a computation result F (a, b). This computation result is a parameter obtained by integrating the respective parameters of the models. Therefore, in a case where the multi-party computation is used as a secure computing method, the secure computing unit 102 includes a plurality of servers. According to the multi-party computation, management of encryption keys and an isolated environment are not necessary, and computation processing is faster. The secure computing unit 102 outputs the parameters of the models obtained as described above to the output unit 103 in the concealed form.

The output unit 103 is a means that transmits the parameters integrated by the secure computing unit 102 to the semiconductor manufacturer servers 200 in the concealed form. The output unit 103 transmits the parameters integrated in a format that allows the semiconductor manufacturer servers 200 to update the parameters of the models. At the time of transmission to the semiconductor manufacturer servers 200, the output unit 103 can transmit differences (only improvements) of the updated parameters rather than the updated parameters.

The operation of the secure computing system 100 configured as described above will be described with reference to a flowchart of FIG. 3.

FIG. 3 is a flowchart illustrating an outline of an operation of the secure computing system 100 according to the first example embodiment. Note that the process according to this flowchart may be executed based on the program control by the processor described above.

As illustrated in FIG. 3, first, the parameter reception unit 101 receives inputs of concealed parameters of a plurality of models that have been trained in a plurality of semiconductor manufacturers (step S101). Next, the secure computing unit 102 integrates the concealed parameters of the plurality of models through secure computation (step S102). Finally, the output unit 103 outputs the parameters of the models integrated by the secure computing unit 102 in a concealed form (step S103). Then, the secure computing system 100 ends the secure computation operation.

In the secure computing system 100, the secure computing unit 102 integrates a plurality of concealed parameters through secure computation. As a result, it is possible to provide more accurate models while concealing respective parameters of the models.

### Second Example Embodiment

Next, a second example embodiment of the present disclosure will be described in detail with reference to the drawings. Hereinafter, description overlapping with what has been described above will be omitted unless the omission obscures the description of the present example embodiment. An information processing system 11 according to the second example embodiment is used to provide models updated using associative learning using secure computation. These updated models are incorporated, for example, in an analysis tool for predictive maintenance of semiconductor manufacturing devices in factories of respective semiconductor manufacturers. The function of each component in each example embodiment of the present disclosure can be implemented not only by hardware similarly to the computer device illustrated in FIG. 2 but also by a computer device based on program control or firmware. These models are models generated based on relationships between the parameters regarding the operating statuses of the semiconductor manufacturing devices acquired in the past and whether it is necessary to maintain parts. These models are stored in model storage units 211 (211a and 211b) of the respective semiconductor manufacturer servers 210 (210a and 210b).

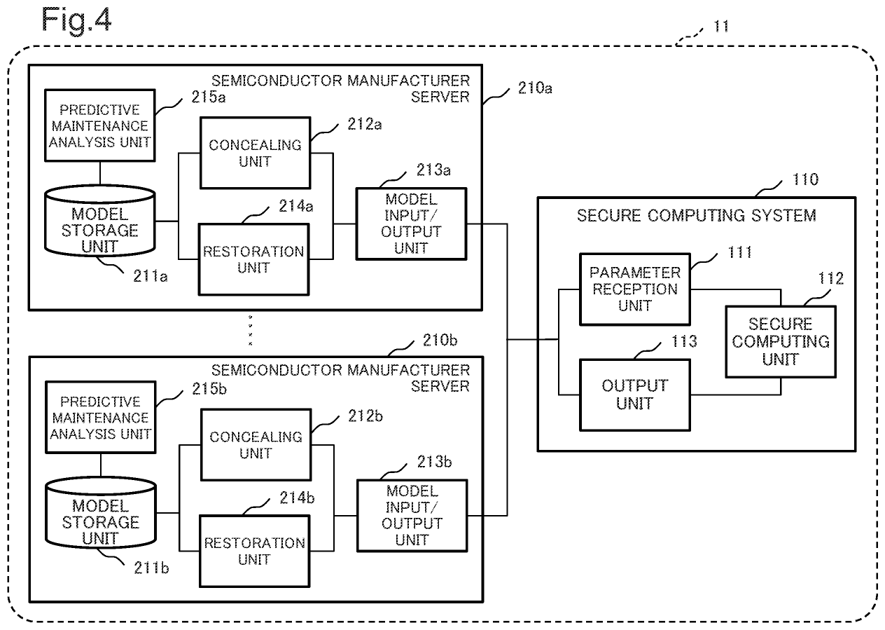

FIG. 4 is a block diagram illustrating a configuration of an information processing system 11 including a secure computing system 110 according to the second example embodiment of the present disclosure. With reference to FIG. 4, the secure computing system 110 and the semiconductor manufacturer servers 210 (210a and 210b) according to the second example embodiment will be described, focusing on differences from the information processing system 10 according to the first example embodiment.

### <Secure Computing System>

The secure computing system 110 integrates parameters of trained models received from the plurality of semiconductor manufacturer servers 210a and 210b by using secure computation. The parameter reception unit 111 receives the parameters of the trained models of the respective semiconductor manufacturers from the semiconductor manufacturer servers 210 through the communication I/F 508. Next, the secure computing unit 112 integrates the received concealed parameters of the models through secure computation in accordance with a predetermined combination rule, and outputs the integrated concealed parameters of the models to the output unit 113 in a concealed form. The output unit 113 transmits the integrated parameters to the semiconductor manufacturer servers 210 through the respective model input/output units 213. In addition, in a case where the parameters are transmitted to the semiconductor manufacturer servers 210 and thereafter the parameters are updated by training the model again in the semiconductor manufacturer servers 210, the secure computing system 110 may receive the updated parameters again. Note that the operations of the parameter reception unit 111, the secure computing unit 112, and the output unit 113 are similar to the operations of the parameter reception unit 101, the secure computing unit 102, and the output unit 103 in the first example embodiment, and thus, description thereof is omitted here.

### <Semiconductor Manufacturer Server>

Each of the semiconductor manufacturer servers 210 includes a model storage unit 211 (211a or 211b) that stores a model that has been trained to perform analysis related to predictive maintenance of the semiconductor manufacturing device, a concealing unit 212 (212a or 202b) that conceals a parameter of the model, a model input/output unit 213 (213a or 213b) that inputs and outputs a parameter to and from the secure computing system 110 in a concealed form, a restoration unit 214 (214a or 214b) that restores the concealed parameter, and a predictive maintenance analysis unit 215 that performs analysis using the parameter of the model updated in the secure computing system 110. In the present example embodiment, the function of each component in the secure computing system 110 after the parameters of the models are updated will be described in detail.

Upon receiving the updated parameters of the models from the secure computing system 110 via the output unit 113, the semiconductor manufacturer server 210 updates the model stored in the model storage unit 211 to a model to which the parameter received from the secure computing system 110 is applied. Specifically, the model input/output unit 213 receives the parameter in the concealed form and outputs the parameter to the restoration unit 214. Next, the restoration unit 214 restores the parameter and replaces the restored parameter with the parameter of the model stored in the model storage unit 211. Next, the predictive maintenance analysis unit 215 performs analysis using the updated model.

Here, analysis related to predictive maintenance of a part of the semiconductor manufacturing device by the predictive maintenance analysis unit 215 will be described. Using the updated model, the predictive maintenance analysis unit 215 estimates necessity of maintaining a part correlated with a parameter based on the parameter of the semiconductor manufacturing device. In the present example embodiment, the part includes an individual part used in the semiconductor manufacturing device or a specific unit including a plurality of parts used in the semiconductor manufacturing device. For example, in a case where a target part to be analyzed for predictive maintenance is a light source, the predictive maintenance analysis unit 215 uses an output of the light source as a parameter.

For example, the predictive maintenance analysis unit 215 performs analysis related to predictive maintenance of a part based on a parameter defined by a difference from a reference value. Here, the reference value is a preset parameter value, for example, an initial parameter value at the time when the operation of the semiconductor manufacturing device is started. The predictive maintenance analysis unit 215 performs analysis related to predictive maintenance of a part based on a difference such as a variation rate from the reference value, and estimates necessity of maintaining the part. For example, when the predictive maintenance analysis unit 215 inputs a specific parameter of the semiconductor manufacturing device to the model stored in the storage device 505, a part correlated with the parameter and information on whether it is necessary to maintain the part are output.

The predictive maintenance analysis unit 215 is incorporated in, for example, a predictive maintenance analysis tool used by the semiconductor manufacturer. The predictive maintenance analysis unit 215 performs analysis related to necessity of maintenance by using the updated model with an operation of the predictive maintenance analysis tool by the user as a trigger. Next, the predictive maintenance analysis unit 215 outputs an analysis result in a state where the user can view the analysis result using the output device 510 such as a display device. The predictive maintenance analysis unit 215 outputs, for example, whether it is necessary to maintain a specific part. In addition, the predictive maintenance analysis unit 215 may output a list of names of parts that need to be maintained. In addition, the predictive maintenance analysis unit 215 may output, for example, information indicating a time at which a part needs to be replaced or inspected as additional information.

In order to increase the accuracy of the result of the analysis performed by the predictive maintenance analysis unit 215, the semiconductor manufacturer server 210 may perform learning again based on the additionally obtained parameter of the semiconductor manufacturing device and further transmit the updated parameter to the secure computing system 110. By repeating the update of the parameters through learning in the respective semiconductor manufacturer servers 210 and the integration of the parameters in the secure computing system 110, for example, until a predetermined condition is satisfied, the accuracy of the model can be further increased. The predetermined condition is stored in, for example, the storage device 505.

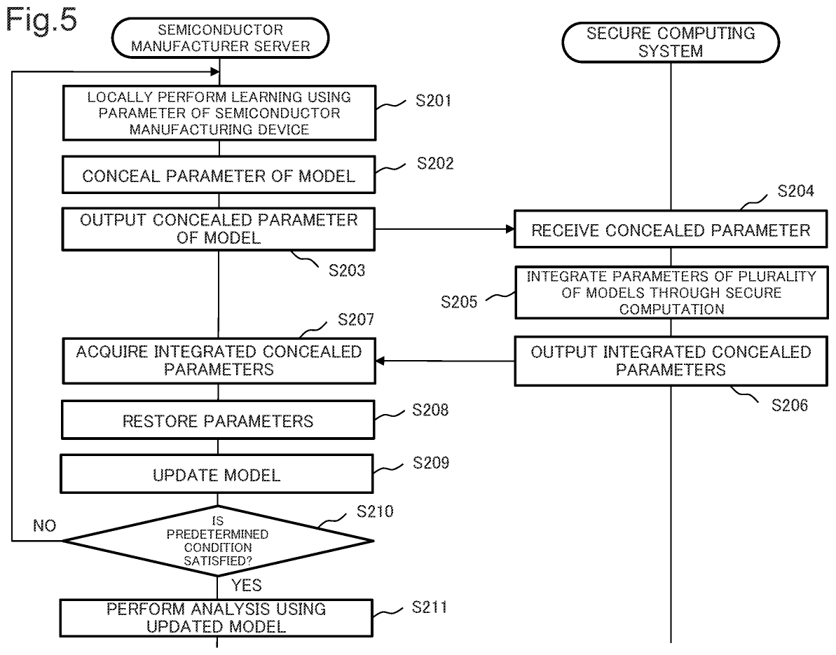

The operation of the information processing system 11 configured as described above will be described with reference to a flowchart of FIG. 5.

FIG. 5 is a flowchart illustrating an outline of an operation of the information processing system 11 according to the second example embodiment. Note that the process according to this flowchart may be executed based on the program control by the processor described above.

As illustrated in FIG. 5, first, the semiconductor manufacturer server 210 locally performs learning based on a parameter of the semiconductor manufacturing device owned by the semiconductor manufacturer and information on necessity of maintenance (step S201). Next, the concealing unit 212 conceals the parameter of the model trained for each semiconductor manufacturer server 210 (step S202). Next, the model input/output unit 213 outputs the parameter to the secure computing system 110 in a concealed form (step S203). Next, the parameter reception unit 111 of the secure computing system 110 receives the concealed parameter (step S204). Next, the secure computing unit 112 integrates a plurality of concealed parameters through secure computation (step S205). Next, the output unit 113 outputs the parameters of the models integrated by the secure computing unit 112 to each of the semiconductor manufacturer servers 210 in the concealed form (step S206). Next, the semiconductor manufacturer server 210 acquires the integrated parameters in the concealed form through the model input/output unit 213 (step S207). Next, the restoration unit 214 restores the concealed parameters (step S208). Next, the semiconductor manufacturer server 210 updates the model stored in the model storage unit 211 to a model to which the restored parameters are applied (step S209). Next, the semiconductor manufacturer server 210 determines whether a predetermined condition is satisfied (step S210). When the predetermined condition is satisfied (step S210: YES), the predictive maintenance analysis unit 215 performs analysis using the updated model, and the flow ends (step S211). When the predetermined condition is not satisfied, the semiconductor manufacturer server 210 returns to step S201 (step S210; NO) and perform the flow again. Then, the information processing system 11 ends the information processing operation.

In the second example embodiment of the present disclosure, analysis related to predictive maintenance of a semiconductor manufacturing devices is performed using a model to which the parameters of the models integrated by the secure computing unit 112 are applied. As a result, it is possible to output a more accurate analysis result.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, although a plurality of operations are described in order in the form of a flowchart, the order in which the operations are described does not limit an order in which the plurality of operations are executed. Therefore, when each example embodiment is implemented, the order in which the plurality of operations are executed can be changed if the content is not affected by the change.

In addition, each of the semiconductor manufacturer servers 210 according to the present example embodiment may further include a maintenance execution unit that performs an arrangement necessary for maintaining a part of the semiconductor manufacturing device based on a result of analysis on predictive maintenance performed by the predictive maintenance analysis unit 215, the maintenance execution unit performing the arrangement necessary for maintaining the part when information indicating that maintenance is necessary is input from the predictive maintenance analysis unit 215. The arrangement necessary for maintenance is, for example, ordering the part in a case where the part needs to be replaced. In a case where a part needs to be repaired, the arrangement necessary for maintenance is arranging a maintenance worker to repair the part. When information that maintenance is not necessary is input to the maintenance execution unit from the predictive maintenance analysis unit 215, the semiconductor manufacturer server 210 executes analysis related to predictive maintenance again through the predictive maintenance analysis unit 215 after a certain period (for example, one month later). In this case, when it is determined that a part needs to be maintained as a result of the predictive analysis performed by the predictive maintenance analysis unit 215, the maintenance execution unit performs an arrangement necessary for the maintenance of the part. As a result, it is possible to execute predictive maintenance of a part without making an additional arrangement when the part needs to be maintained.

Some or all of the above-described example embodiments may be described as in the following supplementary notes, but are not limited to the following supplementary notes.

### Supplementary Note 1

A secure computing system including:
a parameter reception means configured to receive concealed parameters of a plurality of models generated for a plurality of semiconductor manufacturers, each of the plurality of models being used for analysis related to predictive maintenance of a semiconductor manufacturing device;
a secure computing means configured to integrate the plurality of concealed parameters through secure computation; and
an output means configured to output the parameters integrated by the secure computing means in a concealed form.

### Supplementary Note 2

The secure computing system according to supplementary note 1, in which the secure computing means integrates the plurality of concealed parameters through associative learning using secure computation.

### Supplementary Note 3

The secure computing system according to supplementary note 1 or 2, in which the models are models that output necessity of maintaining a part in the semiconductor manufacturing device when a parameter related to an operating status of the semiconductor manufacturing device is input.

### Supplementary Note 4

The secure computing system according to any one of supplementary notes 1 to 3, in which the secure computation is secure distributed computation.

### Supplementary Note 5

A semiconductor manufacturer server including:
a model storage means configured to store a model that has been trained for analysis related to predictive maintenance of a semiconductor manufacturing device:
a model input/output means configured to input a parameter updated from a parameter of the stored model through associative learning using secure computation in a concealed form:
a restoration unit configured to restore the input parameter; and a predictive maintenance analysis means configured to perform analysis related to predictive maintenance of the semiconductor manufacturing device, with the model updated by applying the restored parameter to the stored model.

### Supplementary Note 6

The semiconductor manufacturer server according to supplementary note 5, in which the analysis related to the predictive maintenance of the semiconductor manufacturing device in the predictive maintenance analysis means is analysis related to necessity of maintaining a part of the semiconductor manufacturing device.

### Supplementary Note 7

The semiconductor manufacturer server according to supplementary note 5 or 6, further including a maintenance execution means configured to perform an arrangement related to the maintenance of the semiconductor manufacturing device based on a result of the analysis performed by the predictive maintenance analysis means.

### Supplementary Note 8

The semiconductor manufacturer server according to supplementary note 7, in which the maintenance execution means orders a part necessary in the semiconductor manufacturing device.

### Supplementary Note 9

An information processing system including a plurality of semiconductor manufacturer servers and a secure computing system, in which
each of the plurality of semiconductor manufacturer servers includes:
a model storage unit configured to store a model generated based on a parameter related to an operating status of a semiconductor manufacturing device to perform analysis related to predictive maintenance of the semiconductor manufacturing device;
a concealing unit configured to conceal the parameter of the model stored in the model storage unit;
a model input/output means configured to transmit the model concealed by the concealing unit to the secure computing system in a concealed form; and
a restoration unit configured to restore the concealed parameter, and
the secure computing system includes:
a parameter reception means configured to receive concealed parameters of a plurality of models generated for a plurality of semiconductor manufacturers, each of the plurality of models being used for analysis related to predictive maintenance of a semiconductor manufacturing device;
a secure computing means configured to integrate the plurality of concealed parameters through secure computation; and
an output means configured to output the parameters integrated by the secure computing means in a concealed form.

### Supplementary Note 10

A secure computing method including:
receiving concealed parameters of a plurality of models generated for a plurality of semiconductor manufacturers, each of the plurality of models being used for analysis related to predictive maintenance of a semiconductor manufacturing device;
integrating the plurality of concealed parameters through secure computation; and
outputting the integrated parameters in a concealed form.

### Supplementary Note 11

A recording medium storing a program for causing a computer to execute:
receiving concealed parameters of a plurality of models generated for a plurality of semiconductor manufacturers, each of the plurality of models being used for analysis related to predictive maintenance of a semiconductor manufacturing device;
integrating the plurality of concealed parameters through secure computation; and
outputting the integrated parameters in a concealed form.

### REFERENCE SIGNS LIST

10, 11 Information processing system
100, 110 Secure computing system
101, 111 Parameter reception unit
102, 112 Secure computing unit
103, 113 Output unit
200, 210 Semiconductor manufacturer server
201, 211 Model storage unit
202, 212 Concealing unit
203, 213 Model input/output unit
204, 214 Restoration unit
215 Predictive maintenance analysis unit

What is claimed is:

1. A secure computing system comprising:
a memory storing instructions; and
at least one processor configured to execute the instructions to:
receive concealed parameters of a plurality of models generated for a plurality of semiconductor manufacturers, wherein the each of the plurality of models is used for analysis related to predictive maintenance of a semiconductor manufacturing device;
integrate the plurality of concealed parameters through secure computation; and
output the parameters integrated in a concealed form.

2. The secure computing system according to claim 1, wherein the at least one processor is further configured to execute the instructions to:
integrate the plurality of concealed parameters through associative learning using secure computation.

3. The secure computing system according to claim 1, wherein the models are models that output necessity of maintaining a part in the semiconductor manufacturing device when a parameter related to an operating status of the semiconductor manufacturing device is input.

4. The secure computing system according to claim 1, wherein the secure computation is secure distributed computation.

5. A semiconductor manufacturer server comprising:
a memory storing instructions; and
at least one processor configured to execute the instructions to:
store a model that has been trained for analysis related to predictive maintenance of a semiconductor manufacturing device;
input a parameter updated from a parameter of the stored model through associative learning using secure computation in a concealed form;
restore the input parameter; and
perform analysis related to predictive maintenance of the semiconductor manufacturing device, with the model updated by applying the restored parameter to the stored model.

6. The semiconductor manufacturer server according to claim 5, wherein the analysis related to the predictive maintenance of the semiconductor manufacturing device is analysis related to necessity of maintaining a part of the semiconductor manufacturing device.

7. The semiconductor manufacturer server according to claim 5, wherein the at least one processor is further configured to execute the instructions to:
perform an arrangement related to the maintenance of the semiconductor manufacturing device based on a result of the analysis performed.

8. The semiconductor manufacturer server according to claim 7, wherein the at least one processor is further configured to execute the instructions to:
order a part necessary in the semiconductor manufacturing device.

9. An information processing system including a plurality of semiconductor manufacturer servers and a secure computing system, wherein
each of the plurality of semiconductor manufacturer servers comprising:
a memory storing instructions; and
at least one processor configured to execute the instructions to:
store a model generated based on a parameter related to an operating status of a semiconductor manufacturing device to perform analysis related to predictive maintenance of the semiconductor manufacturing device;
conceal the parameter of the model stored;
transmit the model concealed to the secure computing system in a concealed form; and
restore the concealed parameter, and
the secure computing system comprising:
a memory storing instructions; and
at least one processor configured to execute the instructions to:
receive concealed parameters of a plurality of models generated for a plurality of semiconductor manufacturers, wherein the each of the plurality of models is used for analysis related to predictive maintenance of a semiconductor manufacturing device;
integrate the plurality of concealed parameters through secure computation; and
output the parameters integrated by the secure computing means in a concealed form.

10. A secure computing method comprising:
receiving concealed parameters of a plurality of models generated for a plurality of semiconductor manufacturers, each of the plurality of models being used for analysis related to predictive maintenance of a semiconductor manufacturing device;
integrating the plurality of concealed parameters through secure computation; and
outputting the integrated parameters in a concealed form.

11. A non-transitory recording medium storing a program for causing a computer to execute:
receiving concealed parameters of a plurality of models generated for a plurality of semiconductor manufacturers, each of the plurality of models being used for analysis related to predictive maintenance of a semiconductor manufacturing device;
integrating the plurality of concealed parameters through secure computation; and
outputting the integrated parameters in a concealed form.
